(19) United States
(12) Patent Application Publication
(10) Pub. No.: US 2003/0099432 A1
(43) Pub. Date: May 29, 2003

(54) Optical transmission apparatus and optical transmission module

(75) Inventors: Kanetsu Furuki, Sapporo (JP); Fusako Sugawara, Sapporo (JP); Hideyori Satou, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/096,946

(22) Filed: Mar. 14, 2002

(30) Foreign Application Priority Data
Nov. 28, 2001 (JP) 2001-362890

(51) Int. Cl. G02B 6/28; G02B 6/26; H04B 10/00

(52) U.S. Cl. 385/24; 385/27; 359/161; 359/337

(57) ABSTRACT

The present invention relates to a detection of a cutoff condition of an optical fiber. An optical transmission system includes an optical amplifier, an optical/electrical converter, a dispersion compensator or polarization dispersion compensator. An optical amplifying unit is made up of a former-stage optical amplifier for amplifying and outputting an optical signal inputted thereto, a latter-stage optical amplifier for handling the amplified optical signal from the former-stage optical amplifier and a latter-stage input level detecting section for detecting a latter-stage input level representative of an input level of the optical signal inputted thereto; and a control section for controlling an output level from the optical amplifying section based on the latter-stage input level and a reference latter-stage input level. This configuration enables detecting an off-condition of a fiber with a simple circuit and optical parts already existing therein without suppressing an output level of an optical signal.

### BACKGROUND OF THE INVENTION

(1) Field of the Invention

The present invention relates to an optical transmission apparatus and optical transmission module suitable for the suppression of light leakage occurring, for example, for when an optical fiber cable (which will be referred to hereinafter as an “optical fiber”) falls into an off-condition or cutoff condition.

(2) Description of the Related Art

Optical fibers have been standardized hitherto according to various industrial standards. Of these industrial standards, JIS (Japanese Industrial Standards) C6802 “Radiation Safety Standards for Laser Products”, IEC Standards (International Electrotechnical Commission: International Standards for Electrical Field) 60825, ANSI (American National Standards Institute: Typical Normalization Organization in USA) Z136.1 impose an obligation on a relevant optical transmission system to, when an optical fiber comes off equipment having an output level equal to or more than 10 dBm or falls into a transmission cutoff condition, detect the off-condition or cutoff condition of the optical fiber for suppressing the light leakage to below a safety level. In this case, the off (out-of-place)-condition of the optical fiber signifies that the optical fiber comes off a connector (optical connector, optical connector terminal), an optical module, or the like, while the transmission cutoff condition thereof signifies a cutoff condition of an optical fiber, a disconnected condition in an optical module or optical unit, a disconnected condition between optical transmission apparatus, and other conditions.

The reason for the foregoing obligation to the light leakage level is that, if an optical signal with a high output level leaks from an optical fiber, the leakage light therefrom can exert adverse influence on workers (users).

FIG. 9 is an illustration of an example of configuration of an optical transmission system. In FIG. 9, an optical transmission system, generally designated at reference numeral 210, has a transit function to relay a WDM (Wavelength Division Multiplexing) optical signal including information data, and comprises optical transmission apparatus 100a, 100b and 100c which are in a connected condition to each other through optical transmission lines 70 and 71. The optical transmission apparatus 100b includes an up-direction processing section 80a for handling an upstream optical signal and a down-direction processing section 80b for a downstream optical signal. These up-direction processing 80a and down-direction processing section 80b substantially have the same configuration, and the description thereof will be given hereinbelow of only the up-direction processing section 80a.

In this case, the up-direction signifies a direction from the optical transmission apparatus 100a to the optical transmission apparatus 100b, while the down-direction means a direction from the optical transmission apparatus 100c to the optical transmission apparatus 100b. The following description will be made according to this definition.

In the up-direction processing section 80a, a WDM signal from the optical transmission apparatus 100a is led to a demultiplexer 50a to be demultiplexed into channel optical signals λ1, λ2, . . . , λn (n denotes a natural number) and the demultiplexed optical signals λ1, λ2, . . . , λn undergo the reception processing in optical amplifier units (sending/receiving units) 60a, 60b and 60c, respectively.

In the normal condition, the optical signals λ1, λ2, . . . , λn reception-processed in the optical amplifier units 60a, 60b and 60c are multiplexed in a multiplexer 50b, and this multiplexed WDM signal is transmitted to the optical transmission apparatus 100c. In addition, the interchange of an optical signal with a constant level takes place among the optical transmission apparatus 100a to 100c and among the optical amplifier units 60a to 60c.

On the other hand, at the occurrence of trouble or failure, each of the optical transmission apparatus 100a to 100c detects a transmission cutoff condition (which will be referred to hereinafter as a “cutoff detection”), and stops the optical signal output. For this cutoff detection, the side receiving an optical signal detects a reflection level of the optical signal.

FIG. 10 is an illustration for explaining a conventional optical reflection level detecting method. In FIG. 10, an optical transmission apparatus 60b is composed of an optical amplifier unit 64 and a dispersion compensator (which will hereinafter be referred to equally as a “dispersion compensating section” or “variable dispersion compensator”) 63, with they being connected to each other through optical fibers 72 and connectors 62 in the interior of the apparatus. This optical amplifier 64 includes a former-stage (front) optical amplifier 65 located on the optical transmission apparatus 100a side and a latter-stage (rear) optical amplifier 66 situated on the optical transmission apparatus 100c side and connected to the former-stage optical amplifier 65, and after undergoing the dispersion compensation in the dispersion compensator 63, an optical signal amplified by the former-stage optical amplifier 65 is inputted to the latter-stage optical amplifier 66 to be amplified therein.

(1-1) Former-Stage Optical Amplifier 65

A description will be given hereinbelow of components of the former-stage optical amplifier 65.

(1-1-1) Connectors 62

connectors 62 are for making connections among the former-stage optical amplifier 65, a circuit substrate (not shown) holding the latter-stage optical amplifier 66 and the dispersion compensator 63. Although each of the connectors 62 is connected to a circuit substrate in a manner that it does not easily come off, it can accidentally come off the circuit substrate due to unexpected impact or the like.

(1-1-2) Coupler 65d

A coupler 65d is for issuing an amplified optical signal from an EDF (Erbium-Doped Fiber) 65b as a former-stage output, and further for branching and outputting a reflected return optical signal (reflected light). In this case, the former-stage optical amplifier 65 is under ALC (Automatic Level Control) so that an output level becomes constant.

(1-1-3) Photodiodes 51 and 51a

Each of the former-stage optical amplifier 65 and the latter-stage optical amplifier 66 includes photodiodes (PD) 51 for monitoring a level of an amplified optical signal immediately before outputting and a photodiode 51a for detecting reflected light to monitor a level thereof.

Thus, reflected light is branched by the coupler 65d and detected by the photodiode 51a to produce an electric signal which in turn, is inputted to a control section 53a for detecting a reflection level thereof.

A conventional method of detecting the off-condition or transmission cutoff condition of an optical fiber has made use of the fact that a reflection level increases at the release of the optical fiber.

(1-1-4) Control Sections 53a and 53b

Control sections 53a and 53b are for inputting control signals to excitation LDs (Laser Diodes) (excitation laser diodes) 65e and 66e for putting excitation light into EDFs 65b and 66b, respectively. Moreover, they are designed to notify the off-condition of an optical fiber in the former-stage optical amplifier 65 and the latter-stage optical amplifier 66 to each other.

In addition, each of the control sections 53a and 53b has a comparator (not shown) for making comparison on an input level of an electric signal, and this comparator is connected to the photodiodes 51 and 51a. The photodiode 51 inputs, to the comparator, a monitored value of an output level of an optical signal outputted from the EDF 65b, while the photodiode 51a inputs, to the comparator, a monitored value of a receive level of an optical signal from the adjacent optical transmission apparatus 10a. The comparator makes a comparison between these monitored values in an analog manner. Still additionally, if the monitored value is smaller than a previously set threshold, the comparator receiving the monitored value from the photodiode 51 inverts the logic and outputs it, thereby detecting the off-condition of the optical fiber. This threshold is determined on the basis of a standard value, an experimentally acquired value or the like.

(1-2) Dispersion Compensator 63

The dispersion compensator 63 is for compensating for wavelength dispersion, and is designed to vary its compensation quantity. This wavelength dispersion signifies a distortion of a waveform occurring when an optical signal goes through the optical transmission lines 70 and 71 (in the following description, the wavelength dispersion will equally be referred to simply as “dispersion”).

FIG. 11 is an illustration of an arrangement of the dispersion compensator 63. In FIG. 11, the dispersion compensator 63 is made up of an input level detecting section comprising a coupler 63a, a photodiode 51 and an AD converter (Analog to Digital converter: AD converting section) 63b, and a dispersion compensating module 63c, with connectors 62 being placed at an input terminal and an output terminal, respectively. This dispersion compensating module 63c is for compensating for the wavelength dispersion, and its compensation quantity is under the control of the control sections 53a and 53b (or a control section 20 which will be mentioned later).

With this arrangement, an amplified optical signal outputted from the former-stage amplifier 65 is branched by the coupler 63a so that one branched optical signal is inputted to the dispersion compensating module 63c to be subjected to the dispersion compensation while the other branched optical signal is converted into an electric signal in the photodiode 51 and further is converted into a digital signal in the AD converter 63b. At this time, the level of the optical signal from the dispersion compensator 63 drops.

Incidentally, as another device for compensating for the dispersion, a DCF (Dispersion Compensation Fiber) is also acceptable, and the compensating device is replaceable with various types of dispersion compensating devices with terminals (not shown) for the connectors 62 being mounted on the optical amplifier unit 64.

(1-3) Latter-Stage Optical Amplifier (see FIG. 10)

In the latter-stage optical amplifier 66, couplers 66a, 66c and 66d are equivalent to the couplers 65a, 65c and 65d, and other components marked with the same reference numerals generally have the same functions as those mentioned above.

The latter-stage optical amplifier 66 is for amplifying an optical signal which has lowered in level due to the dispersion compensation in the dispersion compensator 63. In this case, the amplification level is based on a predetermined value (for example, 10 dBm) prescribed according to the standard. The reason that the optical signal is amplified twice is that there is a need to pay attention to the sensitivity of the optical signal in the optical transmission apparatus 100c adjacent to the optical transmission apparatus 100b. For example, if an output level of an optical signal is excessively low, the optical signal is degraded by noises occurring in the optical transmission lines 70 to cause a mistaken detection in the optical transmission apparatus 100c. For this reason, the optical transmission apparatus 100c is required to use a photodiode 51 with a high sensitivity.

Accordingly, in each of the optical transmission apparatus 100a to 100c, the former-stage optical amplifier 65 and the latter-stage optical amplifier 66 are placed in the form of two stages (a plurality of stages: three or more stages) in the optical amplifier unit 64 for securing an output level of 10 dBm. For example, in a case in which an output level from the dispersion compensator 63 is 1 dBm, the latter-stage optical amplifier 66 performs the level amplification corresponding to 9 dBm to output an optical signal with a level of 10 dBm in total.

In addition, with this arrangement, the control section 53a continuously makes a comparison between electric signals from the photodiodes 51 and 51a at all times to implement control in an analog manner.

At this time, when the former-stage optical amplifier 65 detects the off-condition or transmission cutoff condition of an optical fiber, the control section 53a ceases the output of the excitation LD section 65e and notifies the occurrence of the off-condition of the optical fiber to the excitation LD section 66e of the latter-stage optical amplifier 66. This stops the output from the former-stage optical amplifier 65 to the dispersion compensator 63 and further ceases the output from the optical transmission apparatus 100b to the optical transmission apparatus 100c.

On the other hand, in the latter-stage optical amplifier 66, if the off-condition of an optical fiber or the like occurs, the control section 53b stops the output of the excitation LD section 66e and notifies the occurrence of the off-condition of the optical fiber to the excitation LD section 65e of the former-stage optical amplifier 65, thereby similarly terminating the output from the former-stage optical amplifier 65 to the dispersion compensator 63 and the output from the optical transmission apparatus 100b to the optical transmission apparatus 100c.

Thus, it is possible to securely detect the fact that an optical fiber has come off because an unexpected external force has worked thereon or that a worker has disconnected an optical fiber for the purpose of maintenance or the like, thereby surely stop the output of an optical signal with a high output level.

However, in the conventional technique, since the photodiode 51a forming an optical part is used as a reflection level monitor, each of the former-stage optical amplifier 65 and the latter-stage optical amplifier 66 requires optical parts and circuits dedicated to the realization of this monitoring function. This creates a problem of enlargement in circuit scale and apparatus scale.

In addition, when the comparator of each of the control sections 53a and 53b once inputs a stop signal to each of the excitation LD sections 65e and 66e, the operation remains stopped thereafter, which makes it difficult to put the optical transmission system into restoration.

Furthermore, various types of techniques have been proposed for the cutoff detection.

Japanese Patent Laid-Open No. HEI 3-94529 (which will be referred to hereinafter as a “well-known document 1”) discloses an automatic optical output interruption method of automatically interrupt a high output laser signal emitted from a transmitting apparatus at the time of trouble, maintenance or the like of an optical fiber transmission line using a high output laser.

Accordingly, an optical digital signal transmitted from a first station is received by a second station, and when the second station detects a trouble signal inserted into an overhead signal of this optical digital signal, the transmission of an optical digital signal from the second station to the first station is automatically stopped, thus enabling the cutoff of an optical signal in a sure and safe manner.

Moreover, Japanese Patent Laid-Open No. 2000-174706 (which will be referred to hereinafter as a “well-known document 2”) discloses a technique of controlling a power level of a transmission optical signal for the purpose of eliminating the risk on work in an optical line transmission system. According to the control method disclosed in this well-known document 2, an element B detects the loss of signal power transmitted from an element A and notifies the occurrence of a trouble in an optical fiber to the element A through the use of its main signal and monitor signal, thereby making the element A lower the transmission level.

This enables controlling automatically the output power level of a network element (which will be referred to hereinafter as an “element”) on the upstream side, and provides a firmer control method with a higher reliability as compared with a configuration using a conventional technique, and further permits a first optical fiber to get out of a dangerous situation.

Still moreover, Japanese Patent Laid-Open No. HEI 11-205243 (which will be referred to hereinafter as a “well-known document 3”) discloses an optical transmission circuit automatic power stopping system.

This enables an optical amplifying section to reduce automatically an optical signal transmission power level to a safe level in an optical fiber or a passage for enhancing the safety of a repairman, and further allows a transmission apparatus of a transmission system to avoid the effects of power supply surge (wave of an optical signal with an abnormal level).

However, the technique disclosed in the aforesaid well-known document 1 is made to detect a drop of the level by monitoring the overhead in a digital signal, and an optical device, optical unit or transmission apparatus requires an overhead processing section (electric signal processing section) for the decision on a cutoff condition. That is, the optical device and others cannot monitor the connections among an optical amplifier, a dispersion compensator and a polarization dispersion compensator, or among optical processing sections or the like equivalent to these devices.

In addition, the control method disclosed in the well-known document 2 requires a confirmation procedure and complicates the circuit arrangement accordingly. Still additionally, in the system disclosed in the well-known document 3, an optical device or the like cannot make a decision on the cutoff condition without using an overhead processing section, but the use of the overhead processing section causes an increase in circuit scale.

### SUMMARY OF THE INVENTION

The present invention has been developed with a view to eliminating these problems, and it is therefore an object of the invention to provide an optical transmission apparatus and optical transmission module which are capable of, in detecting a cutoff condition of an optical fiber which makes a connection among an optical module, an optical unit, an optical transmission apparatus and others provided in an optical transmission system including optical amplifiers, optical/electrical converters, dispersion compensators, polarization dispersion compensators and other devices, detecting the cutoff condition through the use of simple circuits and existing optical parts without suppressing the output level of an optical signal.

For this purpose, in accordance with the present invention, there is provided an optical transmission apparatus which amplifies an optical signal inputted thereto and outputs the amplified optical signal, comprising a former-stage optical processing section including an optical amplifying section for amplifying and outputting the inputted optical signal, a latter-stage optical processing section including a processing section connected to the former-stage optical processing section for handling the amplified optical signal from the former-stage optical processing section and a latter-stage input level detecting section for detecting a latter-stage input level representative of an input level of the optical signal inputted to the processing section, and a control section for controlling an output level from the optical amplifying section on the basis of the latter-stage input level detected by the latter-stage input level detecting section and a reference latter-stage input level.

This permits batch monitoring control in a manner that an input level detecting section and excitation LD control section provided previously are used and operated stepwise. Moreover, it is possible to simply place an optical fiber off-condition detecting function additionally without suppressing output level. Still moreover, it is possible to directly detect the cutoff condition of an optical fiber through the use of an optical signal itself and to make a decision on a cutoff condition without using an overhead processing section in an optical device or the like for handling overhead contained in an optical signal, and this differs from the well-known document 1 which discloses a technique of handling overhead contained in an optical signal and using information thereon. Yet moreover, it is possible to monitor a circuit or line between elements A and B through the use of a common monitoring section and to exhibit the same function with a simple configuration, and this differs from the well-known document 2 which requires a confirming procedure.

Furthermore, in accordance with the present invention, there is provided an optical transmission apparatus comprising a former-stage optical processing section including an optical amplifying section for amplifying an optical signal, inputted thereto, to one of a first output level and a second output level and for outputting the amplified optical signal, a latter-stage optical processing section including a processing section connected to the former-stage optical processing section for handling the amplified optical signal from the former-stage optical processing section and a latter-stage input level detecting section for detecting a latter-stage input level representative of an input level of the optical signal inputted to the processing section, and a control section for controlling the optical amplifying section on the basis of the latter-stage input level detected by the latter-stage input level detecting section and one of a first reference latter-stage input level and a second reference latter-stage input level so that an output level from the optical amplifying section assumes the first output level or the second output level.

This permits the employment of a minimum configuration using optical parts existing (already provided) in each optical transmission apparatus without additionally using optical parts such as a reflection level detecting circuit.

Still furthermore, in accordance with the present invention, there is provided an optical transmission apparatus comprising a former-stage optical amplification processing section including a first optical amplifying section for amplifying an optical signal, inputted thereto, to one of a first output level and a second output level and for outputting the amplified optical signal, a latter-stage optical processing section including a second optical amplifying section connected to the former-stage optical amplification processing section for amplifying the amplified optical signal from the former-stage optical amplification processing section and a latter-stage input level detecting section for detecting a latter-stage input level representative of an input level of the optical signal inputted to the second optical amplifying section, and a control section for controlling the first optical amplifying section so that an output level from the first amplifying section assumes the first output level when the latter-stage input level detected by the latter-stage input level detecting section becomes higher than a first reference latter-stage input level and an output level from the first amplifying section assumes the second output level when the latter-stage input level detected by the latter-stage input level detecting section becomes lower than a second reference latter-stage input level.

This enables control by a combination of a plurality of optical modules, for example, including a former-stage optical amplifier, a dispersion compensator and a polarization dispersion compensator.

In addition, in accordance with the present invention, there is provided an optical transmission module which amplifies an optical signal inputted thereto and outputs the amplified optical signal, comprising a former-stage optical processing section including a first optical amplifying section for amplifying an optical signal inputted thereto and outputting the amplified optical signal and a first detecting section for detecting a first level signal corresponding to an output level of the first optical amplifying section, a latter-stage optical processing section including a second optical amplifying section connected to the former-stage optical processing section for amplifying and outputting the amplified optical signal from the former-stage optical processing section and a second detecting section for detecting a second level signal corresponding to an input level of the optical signal inputted to the second optical amplifying section, and a control section for controlling the output level of the first optical amplifying section on the basis of an output of the first detecting section and an output of the second detecting section.

This prevents leakage light from exerting adverse influence on a worker when the worker restores a connector which is in an off-condition.

Still additionally, in this configuration, it is also appropriate that the control section controls the first optical amplifying section so that, when the second level signal detected by the second detecting section is equal to or higher than a predetermined reference level, a first output level from the first detecting section approaches a predetermined first output level set value and, when the second level signal detected by the second detecting section is lower than the predetermined reference level, the first output level from the first detecting section approaches a predetermined second output level set value lower than the first output level set value.

This is for avoiding the effects of a power supply surge occurring for when a transmission apparatus of an optical transmission system is again put into operation after the repair of an optical fiber.

Moreover, it is also possible that the control section is designed to implement control for lowering an output level of the optical amplifying section when the latter-stage input level becomes lower than the reference latter-stage input level. This can make, for example, an optical amplifying unit with a simple circuit.

Still moreover, it is also possible that the former-stage optical processing section and the latter-stage optical processing section are connected to each other in a state where a detachable dispersion compensator is interposed therebetween. This enables the use of the existing optical parts, and the detection of an off-condition of an optical fiber without suppressing the output level of an optical signal.

Yet moreover, it is also possible that the processing section included in the latter-stage optical processing section is constructed as an optical amplifying section made to amplify an inputted signal and to output the amplified inputted signal. This enables the use of a simple circuit and existing (already mounted) optical parts in a manner that a conventional input level detecting section or excitation LD control section is operated in a stepwise fashion.

Furthermore, it is also appropriate that the control section includes at least a main control section and a latter-stage input level detection control section and the latter-stage input level detection control section makes a comparison between a reference latter-stage input level taken as a reference level forming one of a first reference input level and a second reference level in the main control section and the input level detected. This permits the detection of a cutoff condition without suppressing the output level of an optical signal.

Still furthermore, it is also appropriate that the former-stage optical amplification processing section includes an output level detecting section for detecting an output level of the first optical amplifying section and the control section includes at least a main control section and a former-stage output level control section, and the main control section sets, as a set value, one of a first set value corresponding to the first output level and a second set value corresponding to the second output level and the former-stage output level control section makes a comparison between a signal detected by the output level detecting section and the set value for controlling the first optical amplifying section. This contributes greatly to stable interchange of optical signals.

In addition, it is also possible that the former-stage optical processing section and the latter-stage optical processing section are connected through an optical fiber to each other in a state where a dispersion compensator detachable from the optical transmission module is interposed therebetween. This increases the application of the optical transmission system and similarly enables easy addition of an optical fiber off-condition detecting function without suppressing the output level.

### BRIEF DESCRIPTION OF THE DRAWINGS

FIG. 1 is an illustration of a configuration of an optical transmission system according to a first embodiment of the present invention;

FIG. 2 is a block diagram schematically showing an optical transmission apparatus according to the first embodiment of the present invention;

FIG. 3 is an illustration useful for explaining an optical amplifying unit control method according to a second embodiment of the present invention;

FIG. 4 is a state transition diagram of a former-stage optical amplifier according to the second embodiment of the present invention;

FIG. 5 is a state transition diagram of a latter-stage optical amplifier according to the second embodiment of the present invention;

FIG. 6 is an illustration useful for explaining a control sequence according to the second embodiment of the present invention;

FIG. 7 is an illustration useful for explaining a three-stage optical amplifying unit according to a modification of the second embodiment of the present invention;

FIG. 8 is an illustration useful for explaining a control sequence according to the modification of the second embodiment of the present invention;

FIG. 9 is an illustration of an example of a configuration of an optical transmission system;

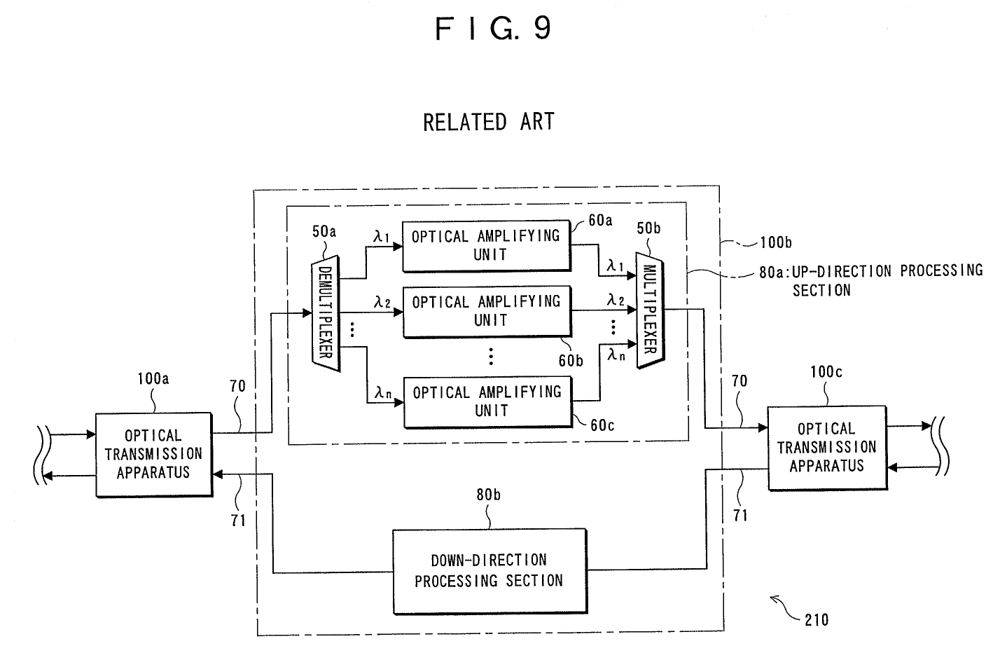

FIG. 10 is an illustration for explaining a conventional optical reflection level detecting method; and

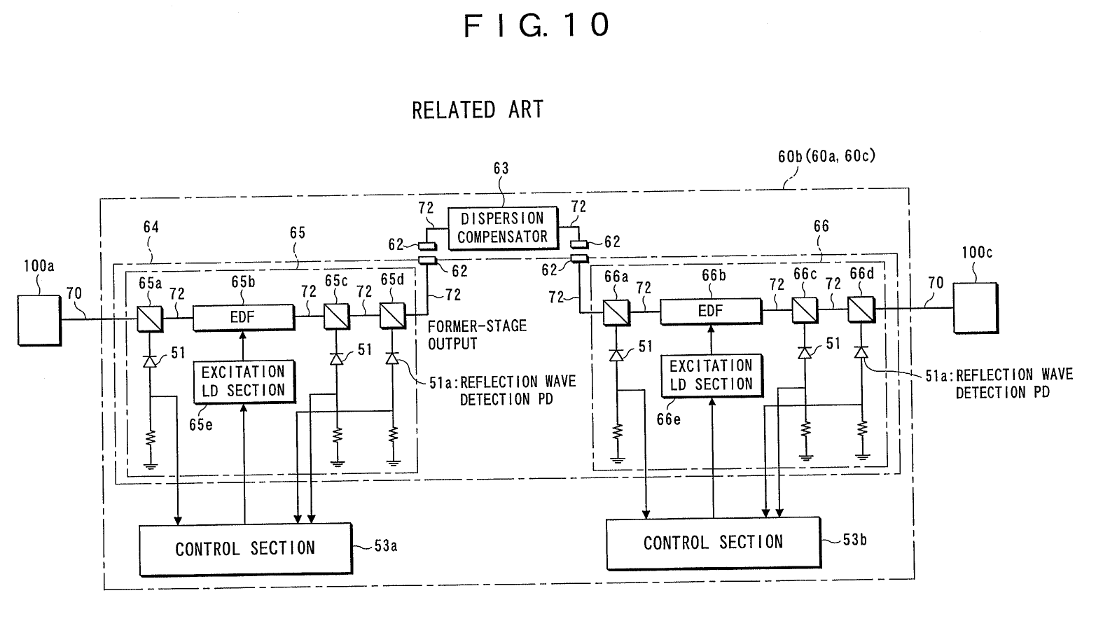

FIG. 11 is an illustration of an arrangement of a dispersion compensator.

### DESCRIPTION OF THE PREFERRED EMBODIMENTS

Embodiments of the present invention will be described hereinbelow with reference to the drawings.

(A) Description of First Embodiment of the Invention

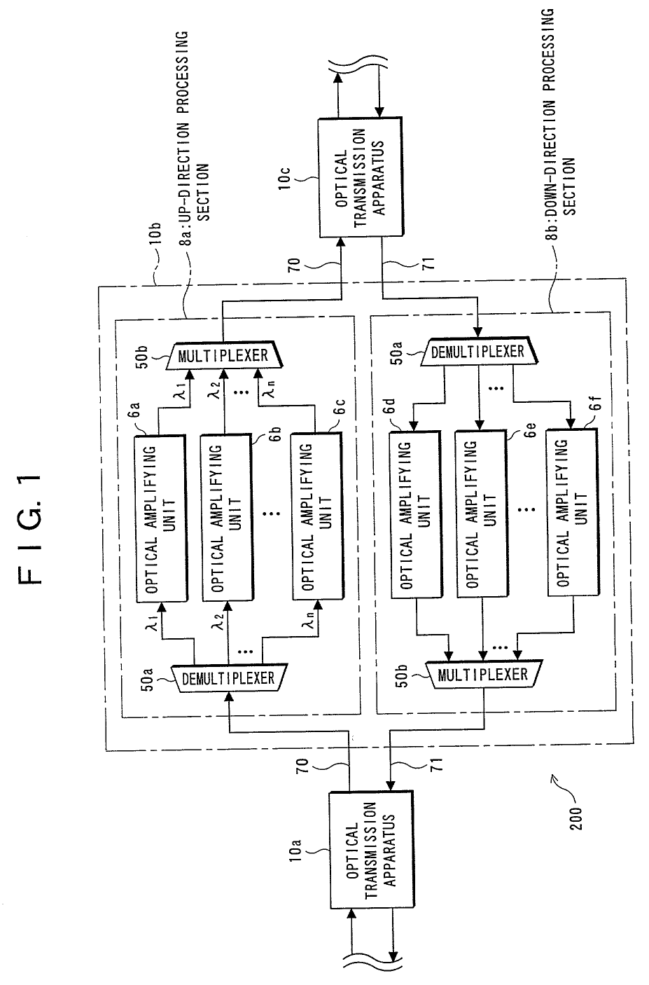

FIG. 1 is an illustration of a configuration of an optical transmission system according to a first embodiment of the present invention. In FIG. 1, an optical transmission system, generally designated at reference numeral 200, has a protective function to interchange a WDM signal including information data, and is made up of optical transmission apparatus 10a, 10b and 10c each having a function to relay an optical signal, with these optical transmission apparatus 10a to 10c being connected through optical transmission lines 70 and 71. This optical transmission system 200 is designed to detect an off-condition or transmission cutoff condition of an optical fiber for suppressing leakage light to below a safe level. Parts of the optical transmission system 200 will be described hereinbelow in order.

(2-1) Optical Transmission Lines 70 and 71

The optical transmission lines 70 and 71 comprise optical fibers for transmitting optical signals in an up-direction (direction from the optical transmission apparatus 10a to the optical transmission apparatus 10b) and in a down-direction (direction from the optical transmission apparatus 10b to the optical transmission apparatus 10a), respectively. The following description will be given about the “up-direction”, unless otherwise specified particularly, for that the method of handling a trouble or failure of an optical signal in the down-direction are the same as that in the up-direction.

(2-2) Optical Transmission Apparatus 10a, Optical Transmission Apparatus 10b and Optical Transmission Apparatus 10c

The optical transmission apparatus 10b is for amplifying an optical signal (a first optical signal), inputted thereto, and outputting the amplified optical signal (a first amplified optical signal). This optical transmission apparatus 10b is made to conduct relay transmission of a WDM signal, and is composed of an up-direction processing section 8a for handling (amplifying) an optical signal in an up-direction and a down-direction processing section 8b for handling (amplifying) an optical signal in a down-direction. The up-direction processing section 8a is made up of a demultiplexer 50a for demultiplexing a WDM signal, optical amplifying units (transmission/receive units) 6a, 6b, . . . , 6c for receiving and handling channel optical signals, λ1, λ2, . . . , λn outputted from the demultiplexer 50a, and a multiplexer 50b for multiplexing optical signals outputted from the optical amplifying units 6a, 6b, . . . , 6c to output a WDM signal.

Thus, in the up-direction processing section 80a, a WDM signal from the optical transmission apparatus 10a is demultiplexed by the demultiplexer 50a into channel optical signals λ1, λ2, . . . , λn which in turn, are reception-handled in the optical amplifying units 6a, 6b, 6c to output optical signals with levels defined according to a standard. Moreover, the optical signals λ1, λ2, . . . , λn with levels satisfying the standard are multiplexed in the multiplexer 50b, and then transmitted to the optical transmission apparatus 10c in the form of a WDM signal. Still moreover, for making the levels of the optical signals constant, ALC control takes place between the optical transmission apparatus 10a and 10b and between the optical transmission apparatus 10b and 10c.

Furthermore, the down-direction processing section 8b is made up of a demultiplexer 50a, optical amplifying units 6d, 6e, 6f and a multiplexer 50b, and the optical signal processing in the down-direction is the generally same as the processing in the up-direction.

The optical amplifying units 6a to 6c and 6d to 6f will be mentioned in detail later. Each of the demultiplexers 50a and the multiplexers 50b is in the form of a well-known optical module, and the detailed description thereof will be omitted for brevity. Each of the optical transmission apparatus 10a and 10c has a function equivalent to that of the optical transmission apparatus 10b, and the double description will be omitted for simplicity.

(2-2-1) Optical Transmission Apparatus 10b (10a, 10c)

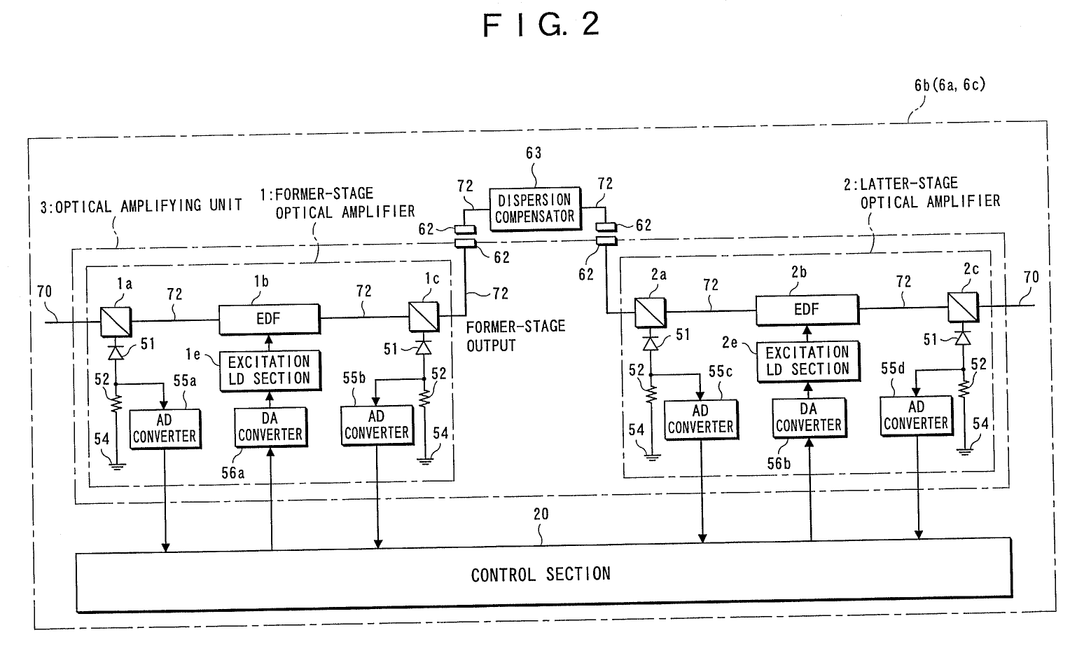

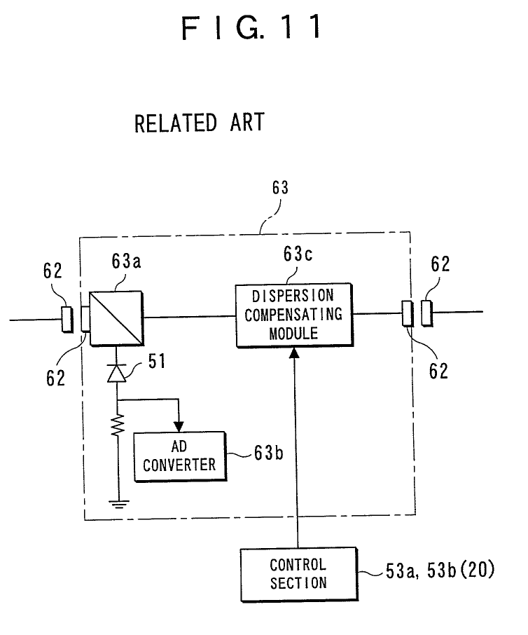

FIG. 2 is a block diagram schematically showing an optical transmission apparatus 10b according to a first embodiment of the present invention. In FIG. 2, the optical transmission apparatus 10b is made up of a two-stage optical amplifying unit 3 comprising a former-stage optical amplifier 1 and a latter-stage optical amplifier (latter-stage optical processing section) 2, a dispersion compensator 63 (see FIG. 11) and a control section 20. Moreover, reference numeral 72 designates an optical fiber in the interior of the optical transmission apparatus 10b. The optical transmission apparatus 10a and 10c have an arrangement similar to that of the optical transmission apparatus 10b.

In this configuration, the former-stage optical amplifier 1 includes an optical amplifying section (first optical amplifying section) for amplifying an optical signal (the first optical signal) inputted thereto and outputting an amplified optical signal (a second amplified optical signal), and functions as a former-stage optical processing section. This optical amplifying section is composed of an EDF 1b and excitation LD section 1e which will be mentioned later, and it will be referred to hereinafter as an “optical amplifying section (1b, 1e)”.

The dispersion compensator 63 is connected to the two-stage amplifying unit 3 for compensating for wavelength dispersion of an optical signal amplified therein. Moreover, the former-stage optical amplifier 1 and the latter-stage optical amplifier 2 are coupled to each other in a state where the dispersion compensator 63, which is of a detachable type, is interposed therebetween.

The latter-stage optical amplifier 2 is connected to the former-stage optical amplifier 1, and is composed of a first processing section (latter-stage processing section) for handling an amplified optical signal (second amplified optical signal) from the former-stage optical amplifier 1 and a latter-stage input level detecting section for detecting a latter-stage input level representative of an input level of an optical signal (second amplified optical signal) inputted to the first processing section.

The first processing section is for amplifying an amplified optical signal from the former-stage optical amplifier 1 and for outputting it, and this function depends upon a second optical amplifying section comprising an EDF 2b, an excitation LD section 2e, a DA converter (Digital to Analogue converter; DA converting section) 56b, and other devices. In the following description, when being referred to as a “second optical amplifying section (2b, 2e, 56b)”, it signifies a processing function (amplifying/outputting function) in the latter-stage optical amplifier 2.

The latter-stage input level detecting section is for detecting a latter-stage input level representative of an input level of an optical signal inputted to the dispersion compensator 63, and this function is realizable with a coupler 2a, a photodiode 51, an AD converter 55c and other devices. This function will be referred to hereinafter as a “latter-stage input level detecting section (2a, 51, 55c)”.

In other words, the former-stage optical amplifier 1 has an optical amplifying section (1b, 1e) which amplifies an optical signal, inputted thereto, to a first output level or a second output level and outputs the amplified optical signal, while the latter-stage optical amplifier 2 has a second optical amplifying section (2b, 2e, 56b) which is connected to the former-stage optical amplifier 1 to amplify the amplified optical signal from the former-stage optical amplifier 1 and a latter-stage input level detecting section (2a, 51, 55c) which detects a latter-stage input level representative of an input level of an optical signal inputted to the second optical amplifying section (2b, 2e, 56b). This applies similarly to the first embodiment and a second embodiment, which will be described later, unless otherwise specified particularly.

Furthermore, the control section 20 is for controlling an output level from the optical amplifying section (1b, 1c) on the basis of a latter-stage input level detected by the latter-stage optical amplifier 2 and a reference latter-stage input level. As will be mentioned later, this control section 20 lowers an output level from the optical amplifying section (1b, 1e) when the latter-stage input level becomes below the reference latter-stage input level.

Still furthermore, the control section 20 is designed to control the optical amplifying section (1b, 1e) on the basis of a latter-stage input level detected by the latter-stage input level detecting section (2a, 51, 55c) and a first reference latter-stage input level or a second reference latter-stage input level so that an output level from the optical amplifying section (1b, 1e) assumes or reaches a first output level or a second output level.

Thus, as the processing function, this provides an optical amplifying/outputting function to be fulfilled by optical amplifiers at two stages: the former-stage optical amplifier 1 and the latter-stage optical amplifier 2 in the two-stage optical amplifying unit.

In addition, a part including at least the two-stage optical amplifying unit 3, the dispersion compensator 63 and the control section 20 can also be provided in the optical transmission apparatus 10b (10a, 10c) in the form of a separate optical transmission module made to amplify an inputted optical signal and output it. In other words, the two-stage optical amplifying unit 3, the dispersion compensator 63 and the control section 20 can also be used in a state modularized.

In this case, the optical transmission module (optical amplifying module) is made up of the former-stage amplifier 1 comprising the optical amplifying section (1b, 1e) for amplifying and outputting an inputted optical signal and the first detecting section (1c, 51, 55b) for detecting a first level signal corresponding to an output level of the optical amplifying section (1b, 1c), the latter-stage optical amplifier 2 comprising the second optical amplifying section (2b, 2e, 56b) connected to the former-stage optical amplifier 1 for amplifying and outputting the amplified optical signal from the former-stage optical amplifier 1 and the second detecting section (2a, 51, 55c) for detecting a second level signal corresponding to an input level of an optical signal inputted to the second optical amplifying section (2b, 2e, 56b), and the control section 20 for controlling an output level of the optical amplifying section (1b, 1e) on the basis of an output of the first detecting section (1c, 51, 55b) and an output of the second detecting section (2a, 51, 55c).

In this configuration, the first detecting section (1c, 51, 55b) comprises a coupler 1c, a photodiode 51 and an AD converter 55b which will be mentioned later, while the second detecting section (2a, 51, 55c) comprises a coupler 2a, a photodiode 51 and an AD converter 55c which will be mentioned later. Moreover, the second optical amplifying section (2b, 2e, 56b) comprises an EDF 2b, an excitation LD section 2e and a DA converter 56b.

(2-2-2) Former-Stage Optical Amplifier 1

The former-stage optical amplifier 1 fulfills three kinds of features: an input level detecting function (former-stage input level detecting function), an optical amplifying/outputting function and an output level detecting function. These functions will be described hereinbelow in order.

(2-2-2-1) Former-Stage Input Level Detecting Function

The former-stage input level detecting function is for detecting a former-stage input level indicative of an input level of an optical signal, and is realized by the cooperation among the former-stage input level detecting section (1a, 51, 55a) comprising the coupler 1a, the photodiodes 51 and the AD converter 55a, resistors 52, a microprocessor (not shown), a ROM (Read Only Memory) (not shown), a RAM (Random Access Memory) (not shown) and others. In this case, the former-stage input level detecting section (1a, 51, 55a) is for displaying the former-stage input level detecting function.

The coupler 1a is for branching and outputting a portion of an optical signal from the adjacent optical transmission apparatus 10a, and each of the photodiodes 51 is an element for outputting an analog electric signal corresponding to an intensity of a received optical signal, and is for realizing an optical detecting function and an optical monitoring function. Moreover, the AD converter 55a is for converting an analog electric signal from the photodiode 51 into a digital signal and outputting it. Each of the resistors 52 acts as a load to be imposed on an output voltage of each of the photodiodes 51, and each of common lines (earth) 54 represents a common electric potential.

The former-stage input optical level is monitored by the former-stage input level detecting function, and when the former-stage input level drops, the excitation LD section 1e (or excitation LD section 2e) is put into an off state.

(2-2-2-2) Optical Amplifying/Outputting Function

The optical amplifying/outputting function is a function to amplify an inputted optical signal to two levels and output the amplified optical signals, and is realized through the cooperation among the EDF 1b, the excitation LD section 1e and the DA converter 56a. Moreover, the cooperation among the EDF 1b, the excitation LD section 1e and an optical fiber making a connection between the EDF 1b and the excitation LD section 1e provides the optical amplifying section (1b, 1e).

The EDF 1b is an erbium doped optical fiber, and the excitation LD section 1e is for outputting an amplified optical signal after the amplification to a desired level under the control of the control section 20 and its function is realizable with a laser diode. Moreover, the DA converter 56a is for converting a digital control signal, outputted from the control section 20, into an analog control signal and for outputting it.

(2-2-2-3) Output Level Detecting Function

The output level detecting function is a function to detect an amplification level of an amplified optical signal, and is realizable through the cooperation among the coupler 1c, the photodiodes 51, the AD converter 55b, the resistors 52 and others. In this case, the coupler 1c is for outputting an optical signal, outputted from the EDF 1b, as a former-stage output and for branching a portion from the optical signal to output the portion of the optical signal, and the AD converter 55b is for converting an analog signal from the photodiode 51 into a digital signal and output it. Incidentally, the components other than these, marked with the same reference numerals as those used above, have the same or corresponding functions, and the description thereof will be omitted for brevity.

(2-2-3) Latter-Stage Optical Amplifier 2

The latter-stage optical processing section 2 is constructed as a latter-stage optical amplifier which amplifies an amplified optical signal from the former-stage optical amplifier 1, and this latter-stage optical amplifier 2 is made to amplify the level of an amplified optical signal undergoing the detection of a latter-stage input level to a desired level for outputting an amplified optical signal. The arrangement of this latter-stage optical amplifier 2 is generally the same as that of the former-stage optical amplifier 1. That is, the coupler 2a, the AD converter 55c, the EDF 2b, the excitation LD section 2e, the DA converter 56b, the coupler 2c and the AD converter 55d substantially have the same functions as the coupler 1a, the AD converter 55a, EDF 1b, the excitation LD section 1e, the DA converter 56a, the coupler 1c and the AD converter 55b, respectively.

In addition, an optical signal amplified and outputted from the former-stage optical amplifier 1 is compensated for dispersion in the dispersion compensator 63 and is again amplified in the latter-stage optical amplifier 2. Still additionally, the latter-stage output level detecting section comprising the coupler 2c, the photodiode 51 and the AD converter 55d is made to detect the amplification level of an amplified optical signal. This function will be referred to hereinafter as a “latter-stage output level detecting section (2c, 51, 55d)”.

Moreover, the cooperation among the coupler 2a, the photodiode 51 and the AD converter 55c provides a latter-stage input level detecting section which detects a latter-stage input level representative of an input level of an amplified optical signal. This function will be referred to hereinafter as a “latter-stage input level detecting section (2a, 51, 55c)”.

Still moreover, the cooperation among the EDF 2b, the excitation LD section 2e and the DA converter 56b provides a second optical amplifying section to handle (amplification-process) an amplified optical signal undergoing the latter-stage input level detection. In other words, a processing section, the latter-stage optical amplifier (latter-stage optical processing section) 2 retains, exhibits an optical amplifying function (optical amplification processing function) for amplifying an input signal and outputting it. This function will be referred to hereinafter as a “second optical amplifying section (2b, 2e, 56b)”.

Furthermore, it is known that the latter-stage optical amplifier 2 uses a variable attenuator (VAT) as needed, and the second optical amplifying section (2b, 2e, 56b) can include the VAT in addition to the coupler 2a, the photodiode 51 and the AD converter 55c.

Accordingly, in a case in which an output level from the former-stage optical amplifier 1 falls considerably below a value predetermined according to a standard, or when a level of an optical signal is degraded largely due to the dispersion compensation in the dispersion compensator 63, the latter-stage optical amplifier 2 is made to amplify and output an optical signal from the dispersion compensator 63 for securing an output level forming a normal value.

Thus, since the two-stage optical amplifying unit 3 can output an optical signal with a constant level at all times, the sensitivity on the reception of an optical signal becomes stable in the optical transmission apparatus 10c adjacent to the optical transmission apparatus 10b, thereby preventing the occurrence of mistaken detection stemming from noise or the like arising in the optical transmission lines 70.

From the above, the optical transmission apparatus 10b shown in FIG. 2 is made up of the former-stage optical amplifier 1 including the optical amplifying section (1b, 1e) for amplifying an inputted optical signal to a first output level or a second output level and then for outputting it, the latter-stage optical amplifier 2 including the second optical amplifying section (2b, 2e, 56b) connected to the former-stage optical amplifier 1 for amplifying the amplified optical signal from the former-stage optical amplifier 1 and the latter-stage input level detecting section (2a, 51, 55c) for detecting a latter-stage input level representative of an input level of the optical signal inputted to the second optical amplifying section (2b, 2e, 56b), and the control section 20 for, when the latter-stage input level detected by the latter-stage input level detecting section (2a, 51, 55c) becomes higher than a first reference latter-stage input level, controlling the optical amplifying section (1b, 1c) so that an output level from the optical amplifying section (1b, 1e) becomes equal to the first output level and for, when the latter-stage input level detected by the latter-stage input level detecting section (2a, 51, 55c) becomes lower than a second reference latter-stage input level, controlling the optical amplifying section (1b, 1e) so that an output level from the optical amplifying section (1b, 1e) becomes equal to the second output level. Moreover, the former-stage optical amplifier 1 and the latter-stage optical amplifier 2 are connected through an optical fiber to each other in a state where the dispersion compensator 63 detachable from the optical transmission module is interposed therebetween.

Incidentally, the two-stage optical amplifying unit 3 can also include three or more stages of amplifiers. The flow of an optical signal in the down-direction is the generally same as that in the up-direction in the down-direction processing section 8b (see FIG. 1), and the further description will be omitted for simplicity.

(2-3) Dispersion Compensator 63

The dispersion compensator 63 is for compensating for wavelength dispersion, and is of a type variable in compensation quantity. This dispersion compensator 63 is designed to compensate for distortion of a waveform occurring for when an optical signal runs the transmission lines 70 and the optical fibers 72, with the optical signal compensated therefor being again inputted to the latter-stage optical amplifier 2 to be amplified therein.

This dispersion compensator 63 is provided in each of the optical transmission apparatus 10a to 10c. This means that, with respect to an optical signal, the dispersion compensation quantity is optimized in each relaying section. Moreover, since the wavelength dispersion quantity of an optical fiber varies with the passage of time in accordance with variations of environments such as temperature and pressure, the optimum dispersion compensation becomes achievable even if these variations occur.

Accordingly, the connectors 62 are placed in the two-stage optical amplifying unit 3 for easy handling of an optical signal.

In this connection, a DCF can also be connected thereto, in place of the dispersion compensator 63.

Moreover, since it is considered that the dispersion compensator 63 is replaced with a different one in order to meet requirements for dispersion quantity, the dispersion compensator 63 is of a type replaceable by the connectors 62.

(2-3-1) Connectors 62

The connectors 62 are used for making a connection between the optical fibers 72 and the two-stage optical amplifying unit 3, and one or more pairs of terminals (for output and input) are placed in the two-stage optical amplifying unit 3.

In addition, if any one of the connectors 62 falls into an out-of-place condition with respect to the two-stage optical amplifying unit 3 due to some unexpected impact or the like, the input to the latter-stage optical amplifier 2 disappears, and in the latter-stage optical amplifier 2, the cutoff condition detection takes place by a comparison between that input level and a predetermined level. At this time, the control section 20 is immediately alerted to the occurrence of trouble through the use of an alarm (for example, an alarm signal indicative of an alarm) or the like.

As a result, the control section 20 stops the output of the excitation LD section 1e of the former-stage optical amplifier 1, thereby ceasing the output of the leakage light even if the connector 62 is in the off-condition.

Moreover, the control section 20 is equipped with a latter-stage control section which will be mentioned later, and this latter-stage control section makes a comparison between an optical signal level inputted to the latter-stage optical amplifier 2 and a predetermined reference level for detecting the cutoff condition, thereby ceasing the output of an optical signal to the adjacent optical transmission apparatus 10c.

With this design, the operation of the optical signal transmission becomes stable. In addition, since the control of the former-stage optical amplifier 1 and the control of the latter-stage optical amplifier 2 are put in a shared condition, as compared with an optical transmission apparatus based on a conventional technique, the size reduction of the apparatus scale becomes feasible and the cost reduction of the optical transmission apparatus 10b becomes achievable.

As mentioned above, an inputted optical signal in the up-direction is amplified, dispersion-compensated and again amplified in the former-stage optical amplifier 1, and then forwarded to the optical transmission apparatus 10c. Moreover, in the optical transmission system 200, an optical signal outputted from the optical transmission apparatus 10a is amplified at relay in the optical transmission apparatus 10b and then forwarded to the optical transmission apparatus 10c. Accordingly, the transmission of an optical signal becomes stable. The operation in the down-direction is conducted as well as that in the up-direction.

In addition, each of the optical transmission apparatus 10a to 10c according to the present invention eliminates the need for use of a circuit for decoding a trouble signal included in an optical signal, unlike a conventional technique, and there is no need to employ an optical signal handling optical module and optical fiber for a main signal and a sub-signal (for example, a monitor signal or control signal). This enables the simplification of the configuration of the optical transmission apparatus 1b and realizes the optical transmission system 200 with a protective function in a relatively easy way.

Still additionally, in this way, a protective function for an optical amplifier is realizable without using an overhead processing circuit, a monitor signal processing circuit or the like.

A description will be given hereinbelow of the outline of the two-stage optical amplifying unit 3.

(B) Description of Second Embodiment of the Invention

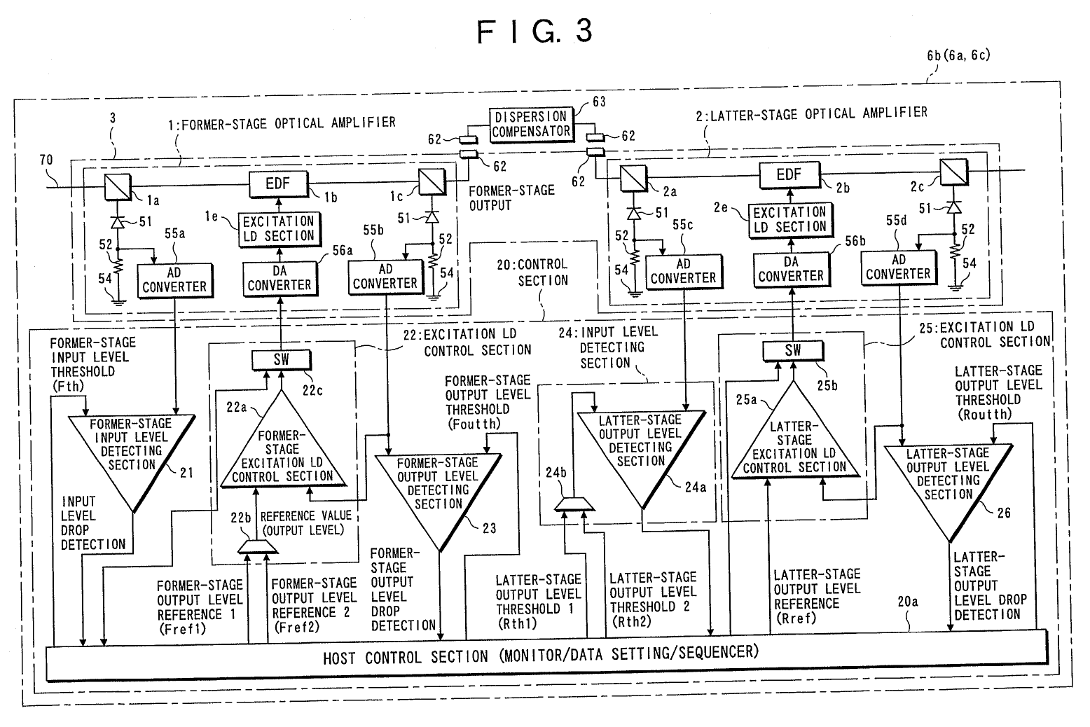

Secondly, referring to FIG. 3, description will be given hereinbelow of a detection level setting method for an input level and an output level, a detection level comparing method and a control method for an output level of an excitation LD section 1e or 2e in the optical transmission apparatus 10b.

FIG. 3 is an illustration useful for explaining a method of controlling a two-stage amplifying unit 3 according to a second embodiment of the present invention. In FIG. 3, parts marked with the same reference numerals as those used above have the same or corresponding functions, and the further description thereof will be omitted for brevity.

(3) Control Section 20

In FIG. 3, a control section 20 is composed of a host control section (main control section) 20a, an input level detecting section (latter-stage input level detection control section) 24 and other units which will be described later. The latter-stage input level detecting section 24 is designed to make a comparison between a reference latter-stage input level set and used as a reference level being one of a first reference input level and a second reference input level by the host control section 20a and an input level detected. Concretely, if a transmission trouble occurs, the control section 20 is made to vary the amplification level of each of amplified optical signals outputted from the former-stage optical amplifier 1 and the latter-stage optical amplifier 2.

As one example of this control, the control section 20 outputs an alarm signal, which will be mentioned later, for notifying a drop of the level of an optical signal. In addition, the control section 20 conducts the monitor of the optical signal level, the setting of comparison data and switching of the reference level on the basis of data from the latter-stage input level control section 24 and data from a former-stage output level detection control section 22.

In this configuration, the control section 20 is made up of a former-stage optical amplification detection/control section comprising a former-stage input level detecting section 21, a former-stage excitation LD detection control section 22 and a former-stage output level detecting section 23, a latter-stage optical amplification detection/control section comprising a latter-stage input level detecting section 24, a latter-stage excitation LD control section 25 and a latter-stage output level detecting section 26, and a host control section 20a for controlling the former-stage optical amplification detection/control section and the latter-stage optical amplification detection/control section.

(3-1) Former-Stage Input Level Detecting Section 21

The former-stage input level detecting section 21 is for detecting a drop of an input level of the former-stage optical amplifier 1, and receives an input level of the former-stage optical amplifier 1 from the AD converter 55a and a threshold Fth (Front Threshold: former-stage input level threshold) from the host control section 20a to inform the host control section 20a of a drop of the input level of the former-stage optical amplifier 1 through the use of the logic “0” or “1”.

In more detail, the former-stage input level detecting section 21 comprises a comparator which receives an input level from the former-stage optical amplifier 1 and the threshold Fth from a microprocessor forming the host control section 20a to output the logic “1” when the input level is equal to or higher than Fth while outputting the logic “0” when the input level is lower than Fth, with the logic “1” or “0” being inputted to the microprocessor. This logic is only one example, and the present invention covers diverse modifications of expression, such as number of bits.

Furthermore, the control section 20 is made to control the detection level in the former-stage input level detecting section 21 on the basis of a reference detection level.

(3-2) Former-Stage Excitation LD Detection Control Section 22

The former-stage excitation LD detection control section 22 is for, when receiving an alarm signal from the latter-stage input level detecting section 24, controlling the amplification level in the excitation LD section 1e on the basis of a reference amplification level or an amplification level detected by the first detecting section (1c, 51, 55b), and functions as a former-stage output level control section.

The former-stage excitation LD detection control section 22 is made to control the output level of the excitation LD section 1e of the former-stage optical amplifier 1, and is composed of a switching section (switch: SW) 22c, a comparing section 22a and a selecting section 22b. The switching section 22c is made to output one of the logic “0” or “1” signal from the host control section 20a and a reference level signal from the comparing section 22a. The selecting section 22b is made to select and output one of two types of former-stage output level reference levels from the host control section 20a. Moreover, the comparing section 22a is for controlling the output level to the excitation LD section 1e so that it agrees with (equals) the former-stage output level reference level from the selecting section 22b. Each of the selecting section 22b and the switching section 22c comprises a selector, while the comparing section 22a comprises a comparator.

A more detailed description will be given of the switching section 22c. In a case in which the excitation LD section 1e ceases its output or issues it at a constant level, a set value from the host control section 20a is outputted to the excitation LD section 1e, and in the case of changing the output level of the excitation LD section 1e, the output of the comparing section 22a is given to the excitation LD section 1e. That is, the on/off of the output of the excitation LD section 1e is directly controllable by the host control section 20a.

In addition, at a change of the output level of the excitation LD section 1e, the switching section 22c obtains the output level of the excitation LD section 1e from the AD converter 55b to control the output level of the excitation LD section 1e so that it agrees with a reference value (output level) inputted to the comparing section 22a. As this reference value, the selecting section 22b receives a level Fref1 (front reference level 1: former-stage output level reference level 1) and a level Fref2 (Front reference level 2: former-stage output level reference level 2) from the host control section 20a, and selects and outputs one of these reference levels to the comparing section 22a.

(3-3) Former-Stage Output Level Detecting Section 23

The former-stage output level detecting section 23 comprises a comparator which receives a former-stage output level from the AD converter 55b and a former-stage output level threshold Foutth (Front output-level threshold) from the host control section 20a to output the logic “1” when the former-stage output level is equal to or higher than this threshold and to output the logic “0” when the former-stage output level becomes lower than the threshold. Thus, the monitoring becomes possible with two steps of detection levels: a detection level 1 and a detection level 2, thereby detecting a drop of the former-stage output level.

Accordingly, the former-stage optical amplifier 1 includes a first detecting section (1c, 51, 55b) for detecting the output level of a first optical amplifying section (1b, 1e) and the control section 20 includes the host control section 20a and the former-stage output level detection control section 22, while the former-stage output level detection control section 22 is designed to make a comparison between a set value and a signal detected by the first detecting section (1c, 51, 55b) for controlling the first optical amplifying section (1b, 1e), where the set value is one of a first set value corresponding to a first output level and a second set value corresponding to a second output level determined in the main control section 20a.

Concretely, the control section 20, when a second level signal detected by the second detecting section (2c, 51, 55d) is equal to or higher than a reference level set in advance, controls the optical amplifying section (1b, 1e) so that the first output level of the first detecting section (1c, 51, 55b) approaches a first output level set value set in advance and when the second level signal detected by the second detecting section (2c, 51, 55d) is lower than a reference level set in advance, controls the optical amplifying section (1b, 1e) so that the first output level of the first detecting section (1c, 51, 55b) approaches a second output level set value set in advance and lower than the first output level set value.

Thus, an optical amplifying unit 6b can utilize intact the existing former-stage input level detecting section (1a, 51, 55a) already provided in the former-stage optical amplifier 1.

In addition, the former-stage optical amplifier 1 also operates at two steps of an output level 1 and an output level 2 through the use of the former-stage excitation LD detection control section 22. Still additionally, each of the former-stage input level detecting section (1a, 51, 55a) and the former-stage excitation LD detection control section 22 is generally monitored by the host control section 20a to be controlled sequentially.

Even if an optical fiber placed on the output side of the former-stage optical amplifier 1 falls into an off-condition, each of the output level 1 and the detection level is set at a level below a safety level, and each of the output level 2 and the detection level 2 is set at an ordinary operating level. That is, this copes with both a trouble occurrence condition and normal operation condition.

(3-4) Latter-Stage Input Level Detecting Section 24

The latter-stage input level detecting section (alarm signal outputting section) 24 is made to output an alarm signal related to a level of an optical signal on the basis of a latter-stage input level and a reference latter-stage input level, and is composed of a selecting section (selector) 24b and a comparing section (comparator) 24a. The selecting section 24b is for selecting a threshold Rth1 or Rth2 through the setting by the host control section 20a, and the comparing section 24a is made to receive the threshold from the selecting section 24b and a latter-stage input level from the AD converter 55c for, when the latter-stage input level is equal to or higher than the threshold, outputting the logic “1” and when the latter-stage input level is lower than the threshold, outputting the logic “0”.

Thus, the latter-stage input level detecting section 24 receives an input level of the latter-stage optical amplifier 2 from the AD converter 55c and a latter-stage input level threshold Rth1 (or Rth2) from the host control section 20a to detect a drop of the input level of the latter-stage optical amplifier 2 for notifying the drop of the input level of the latter-stage optical amplifier 2 to the host control section 20a, for example, through the use of the logic “0” or “1”.

(3-5) Latter-Stage Excitation LD Control Section 25

The latter-stage excitation LD control section 25 is for controlling the output level of the excitation LD section 2e of the latter-stage optical amplifier 2, and is composed of a switching section (switch: SW) 25b and a comparing section (comparator) 25a. The switching section 25b is made to output one of a logic “0”, “1” signal from the host control section 20a and a reference level signal from the comparing section 25a. The comparing section 25a is made to control the output level to the excitation LD section 2e so that it agrees with a level Rref (Rear reference level: latter-stage output level reference level) inputted from the host control section 20a.

As a concrete control method, in a case in which the excitation LD section 2e ceases its output or issues it at a constant level, the switching section 25b outputs a set value from the host control section 20a to the excitation LD section 2e, while, in the case of a change of the output level of the excitation LD section 2e, it supplies the output of the comparing section 25a to the excitation LD section 2e. On the other hand, for a change of the output level of the excitation LD section 2e, the output level of the excitation LD section 2e is derived from the AD converter 55d, and the output level of the excitation LD section 2e is controlled so that it agrees with the Rref inputted to the comparing section 25a.

(3-6) Latter-Stage Output Level Detecting Section 26

The latter-stage output level detecting section (comparator) 26 is made to receive a latter-stage output level from the AD converter 55d and a latter-stage output level threshold Routth (Rear output-level threshold) from the host control section 20a for, when the latter-stage output level is equal to or higher than the threshold, outputting the logic “1” and for, when the latter-stage output level becomes lower than the threshold, outputting the logic “0”. This is for the detection of a drop of the latter-stage output level.

(4) Host Control Section 20a

The functions of the host control section 20a are realizable by the cooperation among a microprocessor having an arithmetic feature, a ROM, a RAM, and others.

(4-1) Level Detection/Monitor Function and Comparison Data Setting Function

The host control section 20a monitors information on an input level of the latter-stage optical amplifier 2 through the AD converter 55c. On the other hand, the output level of the latter-stage optical amplifier 2 is monitored by the AD converter 55d, and the excitation LD section 2e is controlled by the DA converter 56b, thus implementing the stabilization control of the latter-stage optical amplifier 2.

In addition, the microprocessor controls an input level drop detection value for the latter-stage optical amplifier 2 so that it agrees with each of a desired value which can be set by a worker and a low level detection value available for the detection of a cutoff condition. Still additionally, the microprocessor controls the output level of the former-stage optical amplifier 1 so that it agrees with each of a desired value which can be set by the worker and a very low level useful for the detection of a cutoff condition.

The above-mentioned features are the level detection/monitor function and comparison data setting function the host control section 20a retains.

(4-2) Sequencer Representative of Reference Level Switching Processing

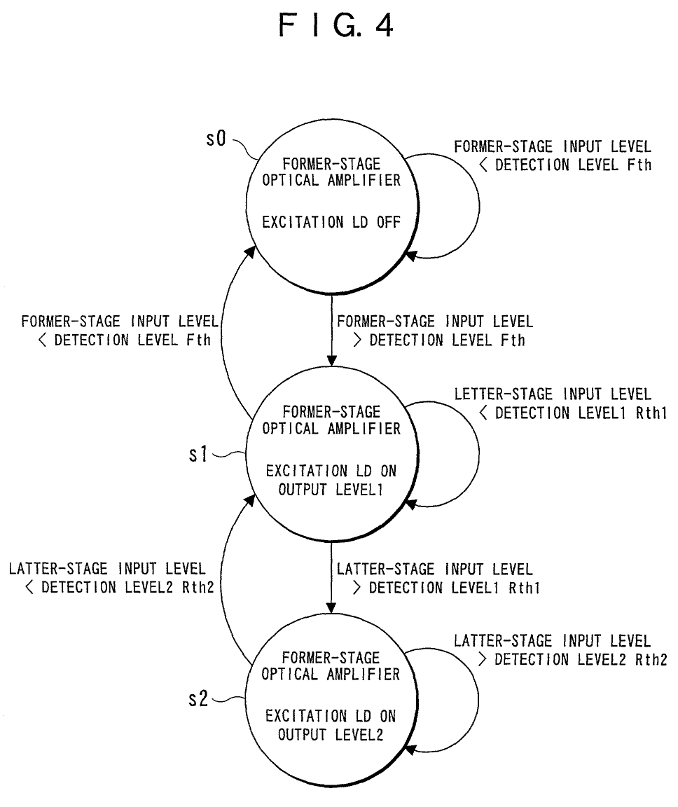

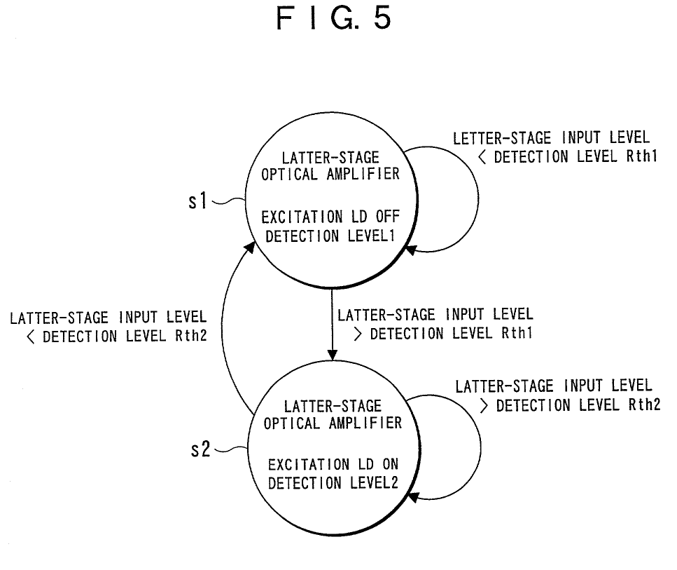

The host control section 20a also functions as a sequencer, and controls the former-stage optical amplifier 1 and the latter-stage optical amplifier 2 on the basis of states and events (such as level variation) as shown in FIGS. 4 and 5.

FIG. 4 is a state transition diagram of the former-stage optical amplifier 1 according to the second embodiment of the present invention. In FIG. 4, a state s0 represents a state to be taken for when the excitation LD section 1e or 2e is set in a turn-off condition, a state s1 denotes a state to be taken for when the excitation LD section 1e is in a turn-on condition and the output level of the former-stage optical amplifier 1 assumes a level 1, and a state s2 signifies a state to be taken for when the excitation LD section 1e is in the turn-on condition and the output level of the former-stage optical amplifier 1 switches into a level 2.

A detailed description will be given hereinbelow of these state transitions. At the state s0, if the input level of the former-stage optical amplifier 1 becomes equal to or higher than a detection level Fth, the state shifts to s1, and at this state s1, if the input level of the latter-stage optical amplifier 2 becomes equal to or higher than a detection level 1 (Rth1), the state shifts to s2. On the other hand, at the state s2, if the input level of the latter-stage optical amplifier 2 becomes lower than a detection level 2 (Rth2), the state switches into s1, and at the state s1, if the input level of the former-stage optical amplifier 1 becomes lower than the detection level Fth, the state returns to s0. Meanwhile, at each of the states s0, s1 and s2, even if the input level of the former-stage optical amplifier 1 becomes lower than the detection level Fth, the state transition does not take place. Moreover, at the states s1 and s2, even if the input level of the latter-stage optical amplifier 2 becomes equal to or higher than the detection level 1 (Rth1) and the detection level 2 (Rth2), the state transition also does not take place.

Incidentally, each of the states s0 to s2 shows one example, more fragmentation of the states are also acceptable.

Secondly, referring to FIG. 5, a description will be given hereinbelow of a state transition of the latter-stage optical amplifier 2.

FIG. 5 is a state transition diagram of the latter-stage optical amplifier 2 according to the second embodiment of the present invention. In FIG. 5, a state s1 is the same as the aforesaid state s1, where the excitation LD section 2e of the latter-stage optical amplifier 2 is in a turn-off condition and the detection level is at a level 1, while a state s2 is a state in which the excitation LD section 2e is in a turn-on condition and the detection level is at a level 2.

A more detailed description will be given hereinbelow of the state transitions. At the state s1, if the input level of the latter-stage optical amplifier 2 becomes equal to or higher than a detection level Fth1, the state shifts to s2, and at this state s2, if the input level of the latter-stage optical amplifier 2 becomes lower than a detection level Rth2, the state returns to s1. At this state s1, if the input level of the latter-stage optical amplifier 2 becomes lower than the detection level Rth1, the state transition does not take place. Moreover, at the state s2, if the input level of the latter-stage optical amplifier 2 is equal to or higher than the detection level Rth2, the state transition also does not take place.

The above description is about the states and the state transitions.

Furthermore, the host control section 20a performs the control through the use of these states.

First of all, as an initial state (initial operation), the host control section 20a sets an Fref1 as a former-stage output level reference in the comparing section 22a, and sets the selecting sections 22b and 24b so that the Rth1 is inputted as a latter-stage input level threshold to the comparing section 22a. This setting makes the excitation LD section 1e of the former-stage optical amplifier 1 emits light at an output level 1, and makes the detection of a detection level 1 of the excitation LD section 2e of the latter-stage optical amplifier 2. In a case in which the input level of the latter-stage optical amplifier 2 is lower than the detection level 1, the host control section 20a makes a decision that the former-stage optical amplifier 1 and the latter-stage optical amplifier 2 remain non-connected to each other, and continuously maintains the state s1. Moreover, in a case in which light reception is made in a state where the input level of the latter-stage optical amplifier 2 is higher than (or equal to) the detection level 1, the host control section 20a makes a decision that the connection between the former-stage optical amplifier 1 and the latter-stage optical amplifier 2 is not in an abnormal condition, and shifts each of the former-stage optical amplifier 1 and the latter-stage optical amplifier 2 into the state s2.

In this case, the state s1 signifies a low-level output state for confirming the connection between the former-stage optical amplifier 1 and the latter-stage optical amplifier 2, and the former-stage optical amplifier 1 outputs an optical signal at an output level 1 while the latter-stage optical amplifier 2 detects an input level at a detection level 1. The state s2 is a state in which the output from the excitation LD section 1e or 2e is made at an ordinary output level, and the host control section 20a sets the excitation LD section 1e or 2e to an optimum level. Moreover, the threshold for the detection of an input level is set at a detection level 2 (Rth2).

In the initial state, since the output of the excitation LD section 1e or 2e starts at a level 1 forming a low-level output state, even if the connector 62 between the former-stage optical amplifier 1 and the latter-stage optical amplifier 2 is in an off-condition, it is possible to suppress the leakage light to a safe level.

In addition, if an optical fiber falls into an off-condition at the state s2, since the input level of the latter-stage optical amplifier 2 falls below a threshold of an input level 2, the latter-stage optical amplifier 2 shifts into the state s1, and is controlled to again detect the input level at a detection level 1.

Still additionally, if this input level does not reach the detection level 1, the host control section 20a makes a decision to an off-condition of an optical fiber and shifts the former-stage optical amplifier 1 into an output level 1 state. On the other hand, in a case in which the detection level is between the detection level 1 and the detection level 2, in the latter-stage optical amplifier 2, the operation in the state s2 is continuously conducted because a decision is made that the connectors 62 or an optical fiber are in the normal connection.

(5) Description of Operation

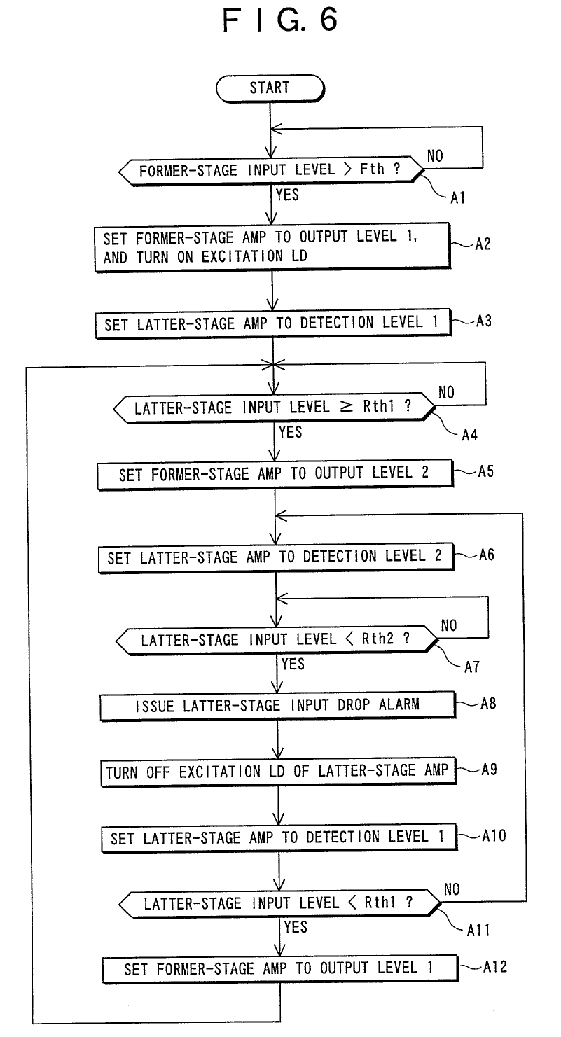

In the above-described configuration, referring to FIG. 6, a detailed description will be given hereinbelow of a control method for the optical transmission apparatus 10b (and the optical transmission apparatus 10a, 10c).

FIG. 6 is an illustration useful for explaining a control sequence according to the second embodiment of the present invention. In FIG. 6, at a step A1, the host control section 20a monitors an input level, and takes a NO route while the former-stage input level is lower than a level Fth set by a worker, to continues a standby condition. On the other hand, if the former-stage input level becomes equal to or higher than the level Fth, the host control section 20a takes an YES route to enter a step A2 for setting the former-stage optical amplifier (former-stage AMP) 1 at an output level 1 so that the excitation LD section 1e becomes an ON condition (operating condition). Subsequently, at a step A3, the host control section 20a sets an optical fiber cutoff detection input level (detection level) for the latter-stage optical amplifier (latter-stage AMP) at a detection level 1 (Rth1) through the use of an ALC.

At a stepA4, the host control section 20a continuously monitors the input detection level of the latter-stage optical amplifier 2 and, when the input detection level is lower than the Rth1, makes a decision to an off-condition of an optical fiber and takes a NO route to continue the standby condition for maintaining the optical fiber off-condition processing. On the other hand, when detecting an input level equal to or higher than the Rth1, the host control section 20a takes an YES route to proceed to a step A5 for setting the output level of the former-stage optical amplifier 1 to an output level 2, and at a step A6, sets the detection level of the latter-stage optical amplifier 2 to a detection level 2.

Thus, both the former-stage optical amplifier 1 and latter-stage optical amplifier 2 are put into the normal operation. Moreover, the processing in the steps A4 to A6 enables confirming that a normal level has been inputted to the latter-stage optical amplifier 2.

Secondly, through the processing in steps A7 to A10, the host control section 20a monitors that the output of the latter-stage optical amplifier 2 is above a level Rth2 set in advance.

That is, at the step A7, the host control section 20a monitors whether or not the input level of the latter-stage optical amplifier 2 is lower than the Rth2. If the input level becomes equal to or higher than the Rth2, the host control section 20a takes a NO route. On the other hand, if the input level becomes lower than the Rth2, the host control section 20a takes an YES route. Following this, at the step A8, the host control section 20a outputs an alarm indicative of a drop of the input level of the latter-stage optical amplifier 2, and at the step A9, the latter-stage optical amplifier 2 stops (OFF) the output of the excitation LD section 2e, and further at the step A10, the host control section 20a sets the detection level for the latter-stage optical amplifier 2 to the detection level 1.

Furthermore, at a step A11, the host control section 20a monitors whether or not the input level of the latter-stage optical amplifier 2 is lower than the Rth1. If it equals or exceeds the Rth1, the host control section 20a takes a NO route to handle the steps A6 and the following steps. On the other hand, if the input level of the latter-stage optical amplifier 2 is lower than the Rth1, the host control section 20a takes an YES route to set the output level of the former-stage optical amplifier 1 to the output level 1 at a step A12, thereafter handling the step A6 and the steps subsequent thereto.

In this connection, for increasing the output level of the former-stage optical amplifier 1 to the level 2, the host control section 20a can also increase the output level stepwise to avoid the occurrence of surge (wave of an optical signal at an abnormal level). That is, even at the ON/OFF operation of a power supply or the like or the appearance of an abnormal pulse in an electric circuit, it is possible to prevent the occurrence of the surge.

This improves the safety and certainty on manipulation. In this case, there is no need for the host control section 20a to increase the detection level for the latter-stage optical amplifier 2 in a stepwise fashion, and it is also possible that the detection level 2 is set as the detection level to establish a standby condition.

In addition, in the ordinary operation, when the input level of the latter-stage optical amplifier 2 becomes equal to or lower than the Rth2, the latter-stage optical amplifier 2 outputs an input level drop alarm. At this time, when the latter-stage input level does not exceed the Rth1, a decision is made to an off-condition of an optical fiber, and both the former-stage and latter-stage are shifted into cutoff detection standby (output level 1, detection level 1) conditions.

As described above, in the optical transmission system 200, the batch monitoring control is feasible by the stepwise operation through the use of an input level detecting section and excitation LD control section provided beforehand.

That is, for the detection of an off-condition of an optical fiber, in the conventional optical transmission system, a decision therefor depends upon the measurement of a reflection level. On the other hand, in the optical transmission system 200, it is possible to use existing optical parts already provided in each of the optical transmission apparatus 1a to 1c without additionally using optical parts such as a reflection level detecting circuit, which allows the implementation using a minimum configuration.

For example, in the conventional technique, for increasing the circuit scale, the optical level is positively suppressed to below a safety optical level (for example, 9.5 dBm), whereas in the optical transmission system 200, it is possible to easily provide additionally an optical fiber off-condition detection function without suppressing the output level.

Moreover, with this stepwise operation, a two-stage optical amplifying unit 3 is producible with a simple circuit, and in the two-stage optical amplifying unit 3, the existing optical parts are employable, which permits the detection of an off-condition of an optical fiber without suppressing the output level of an optical signal.

In this way, for the detection of a cutoff condition of an optical fiber, when the existing input level detecting section or excitation LD control section is operated in a stepwise manner, the detection of the cutoff condition becomes feasible with simple circuits and through the use of the already existing optical parts without restraining the output level of an optical signal.

(6) Description of Modification

Meanwhile, for implementation, the optical transmission apparatus 10b accepts diverse modification on arrangement.

(6-1) Configuration of Optical Transmission Apparatus 10b

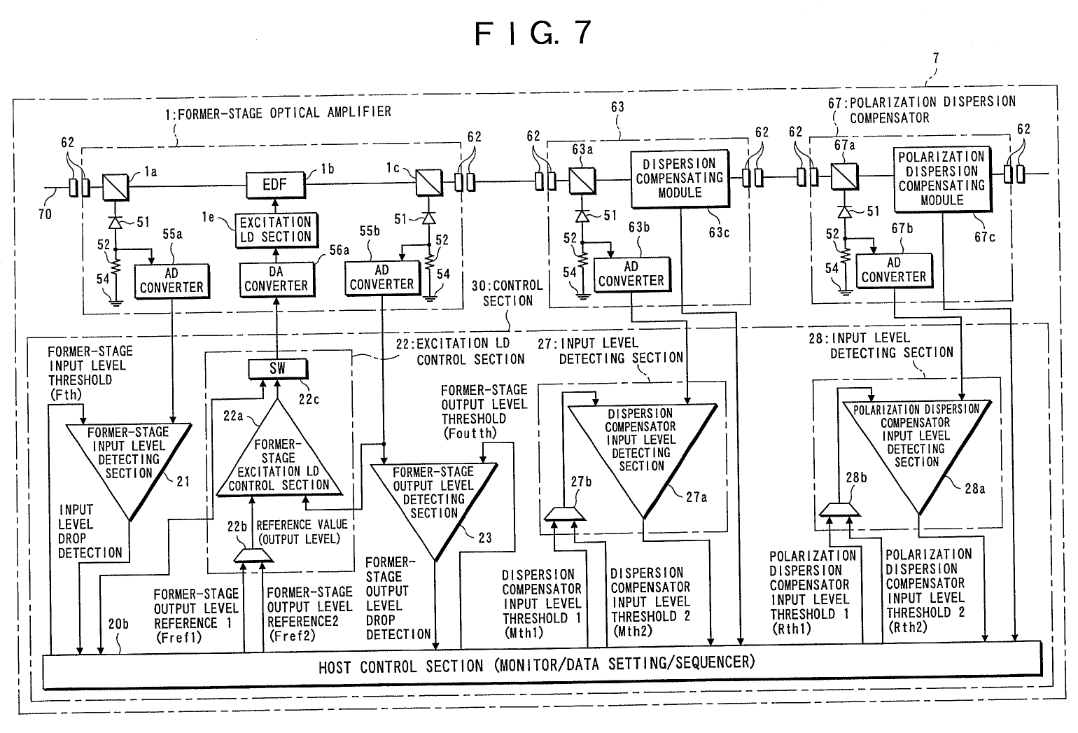

FIG. 7 is an illustration useful for explaining a method of controlling a three-stage optical amplifying unit according to a modification of the second embodiment of the present invention. In FIG. 7, a three-stage optical amplifying unit 7 is made up of a former-stage optical amplifier 1, a dispersion compensator 63, a polarization dispersion compensator 67 and a control section 30. Parts marked with the same reference numerals as those used above exhibit the same or corresponding functions.

The polarization dispersion compensator 67 is for compensating for polarization dispersion, and is composed of a coupler 67a, a photodiode 51, an AD converter 67b and a polarization dispersion compensating module 67c. These coupler 67a and AD converter 67b are the same as the coupler 1a (see FIG. 2) and the AD converter 55a, respectively, and the description thereof will be omitted for simplicity. The polarization dispersion compensating module 67c is made to compensate for the polarization dispersion, and the compensation quantity is under control of the control section 30.

The control section 30 is made up of, in addition to a former-stage optical amplification detecting/control section (former-stage input level detecting section 21, former-stage excitation LD detection control section 22, former-stage output level detecting section 23) for the detection and control of the former-stage optical amplifier 1, a host control section 20b, a dispersion compensator input level detecting section 27 and a polarization dispersion compensator input level detecting section 28.

The dispersion compensator input level detecting section 27 is for detecting an optical level inputted to the dispersion compensator 63, and includes a comparing section 27b and a selecting section 27a. The comparing section 27b comprises a comparator to selectively output the larger of a dispersion compensator input level threshold 1 (Mth1) and dispersion compensator input level threshold 2 (Mth2) inputted from the host control section 20b. The selecting section 27a is connected to the comparing section 27b and further to the dispersion compensator 63 for selectively outputting one of the dispersion compensator input level threshold 1 or 2 and a value from the AD converter 63b, with its feature being realizable with a selector.

Thus, the dispersion compensator input level detecting section 27 is designed to output the logic “1” when an input level from the dispersion compensator 63 is equal to or higher than a threshold given while outputting the logic “0” when a former-stage output level is lower than a threshold.

Accordingly, the dispersion compensator input level detecting section 27 can monitor the input level through the use of two steps of detection levels: a detection level 1 and a detection level 2, and can detect a level drop of the dispersion compensator 63.

In addition, the polarization dispersion compensator input level detecting section 28 is for detecting an optical level inputted to the polarization dispersion compensator 67, and is composed of a comparing section 28b and a selecting section 28a. These comparing section 28b and selecting section 28a are generally the same as the comparing section 27b and the selecting section 27a, respectively.

Thus, the polarization dispersion compensator input level detecting section 28 is made to output the logic “1” when an input level from the dispersion compensator 63 is equal to or more than a threshold given while outputting the logic “0” when a former-stage output level is lower than a threshold.

Accordingly, similarly, the polarization dispersion compensator input level detecting section 28 can monitor the input level through the use of two steps of detection levels: a detection level 1 and a detection level 2, and can detect a level drop of the dispersion compensator 63.

That is, for the control of the former-stage optical amplifier 1, the dispersion compensator 63 and the polarization dispersion compensator 67, the monitoring of the output level of the former-stage optical amplifier 1 is made using two steps of levels and the monitoring of the input levels of the dispersion compensator 63 and the polarization dispersion compensator 67 are made at two steps of levels.

Moreover, this also enables precise detection of an off-condition of an optical fiber through the use of the control method using the two-step level detection and the level setting.

In this case, it is also possible that the dispersion compensator 63 and the polarization dispersion compensator 67 are interchanged in location with each other so that the dispersion compensator 63 deals with the output of the polarization dispersion compensator 67. Moreover, it is also possible that the latter-stage optical amplifier 2 is situated between the dispersion compensator 63 and the polarization dispersion compensator 67 or that the latter-stage optical amplifier 2 is provided with respect to the output of the dispersion compensator 63 and the polarization dispersion compensator 67 connected in series to each other. In these cases, the host control section is provided with a control section for controlling these compensators.

(6-2) Description of Operation

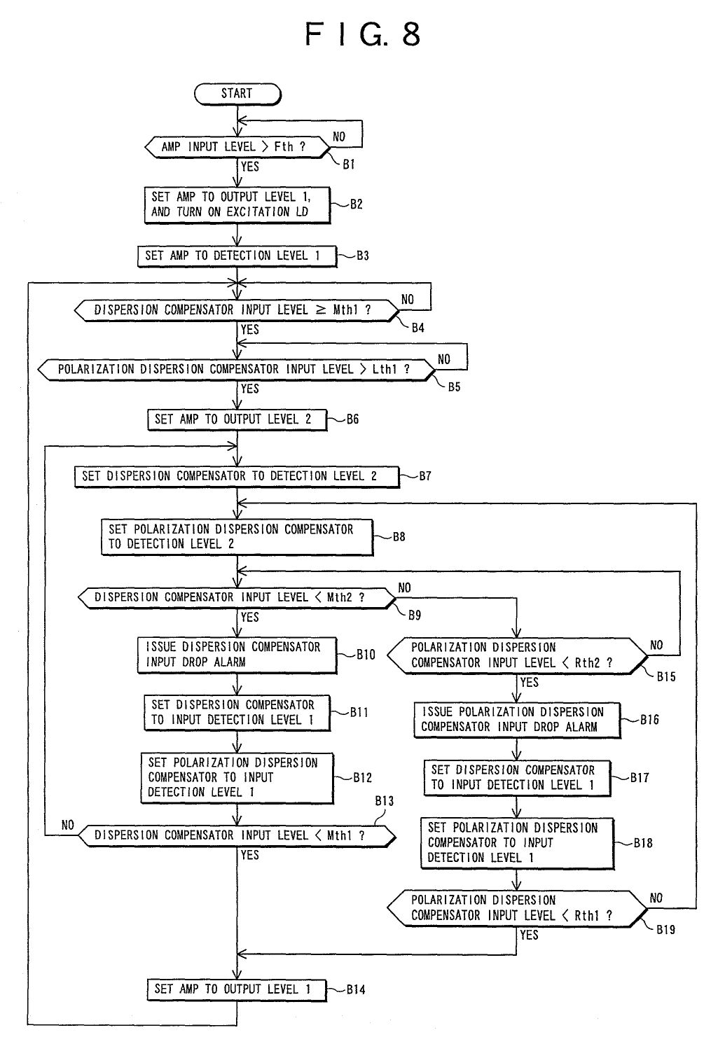

With this configuration, the three-stage optical amplifying unit 7 is controlled through the use of a control sequence shown in FIG. 8.

FIG. 8 is an illustration useful for explaining a control sequence according to the modification of the second embodiment of the present invention. In FIG. 8, at a step B1, the host control section 20b takes a NO route while a former-stage input level to the former-stage optical amplifier (AMP) 1 is lower than a level Fth, and continues a standby condition. On the other hand, when it becomes equal to or higher than the level Fth, the host control section 20b takes an YES route to enter a step B2 for setting the former-stage optical amplifier 1 at an output level 1 and for turning on the excitation LD section 1e. At a step B3, the host control section 20b sets the detection level for the detection of the cutoff condition of an optical fiber of the former-stage optical amplifier 1 to a detection level 1.

In addition, at a step B4, the host control section 20b continues to monitor the input level of the dispersion compensator 63, and when the input level is lower than Mth1, makes a decision to an off-condition of an optical fiber and takes a NO route to continue the standby condition for maintaining the optical fiber off-condition processing. On the other hand, on the detection of an input level equal to or higher than the Mth1, the host control section 20b goes to an YES route for dealing with a step B5. In this step B5, if the input level of the polarization dispersion compensator 67 is lower than Lth1, the host control section 20b goes to a NO route to take a standby condition. On the other hand, if the input level is equal to or higher than the Lth1, the host control section 20b goes to an YES route and, at a step B6, sets the output level of the former-stage optical amplifier 1 to an output level 2.

Following this, the host control section 20b sets the detection level for the dispersion compensator 63 to a detection level 2 (step B7), and sets the detection level for the polarization dispersion compensator 67 to a detection level 2 (step B8).

In addition, the host control section 20b monitors whether or not the input level of the dispersion compensator 63 is lower than Mth2 (step B9). If it is equal to or higher than the Mth2, the host control section 20b takes an YES route to, at a step B10, issue a drop alarm indicative of an input drop to the dispersion compensator 63. Still additionally, at a step B11, the host control section 20b sets the dispersion compensator 63 at an input detection level 1, and at a step B12, the host control section 20b sets the polarization dispersion compensator 67 at the input detection level 1.

After this, at a step B13, the host control section 20b monitors whether or not the input level of the dispersion compensator 63 is lower than the Mth1. If it is equal to or higher than the Mth1, the host control section 20b takes a NO route to handles the step B7 and the following steps. On the other hand, if the input level of the dispersion compensator 63 is equal to or lower than the Mth1, the host control section 20b takes an YES route to, at a step B14, set the output level of the former-stage optical amplifier 1 to an output level 1, then handling the step B4 and the following steps.

Furthermore, at a step B9, if the input level of the dispersion compensator 63 becomes equal to or higher than the Mth2, the host control section 20b takes a NO route to, at a step B15, compare the input level of the polarization dispersion compensator 67 with the Rth2. At this time, if the input level is equal to or higher than the Rth2, the host control section 20b takes a NO route to again conduct the processing in the step B9. On the other hand, if the input level is lower than the Rth2, the host control section 20b takes the YES route to, at the step B16, issue an alarm indicative of an input drop to the polarization dispersion compensator 67. Moreover, the host control section 20b sets the detection level for the dispersion compensator 63 to the input detection level 1 (step B17), and sets the detection level for the polarization dispersion compensator 67 to the input detection level 1 (step B18), and further monitors whether or not the input level of the polarization dispersion compensator 67 is lower than the Rth1 (step B19). If the input level is equal to or higher than the Rth1, the host control section 20b takes the NO route to conduct the step B8 and following steps. On the other hand, if the input level is lower than the Rth1, the host control section 20b takes the YES route to conduct the processing in the step B14.

With this operation, the host control section 20b can make a decision as to whether or not the optical transmission lines 70, 71 and the internal fibers 72 reaches a restored condition.

In addition, in this way, it is possible to execute the control through the use of a combination of three or more types of optical modules including the former-stage optical amplifier 1, the dispersion compensator 63 and the polarization dispersion compensator 67.

As found from the above description, since the optical transmission apparatus 10b detects a low level prior to increasing the output level of an optical signal, when a worker restores an off portion of the connectors, the leakage light does not exert adverse influence on that worker.

As described above, the transmission apparatus of the optical transmission system 200 can eliminate the effects of the power supply surge at the repair of the optical fiber and the resumption of the operation.

(C) Others

It should be understood that the present invention is not limited to the above-described embodiments and the modification thereof, and that it is intended to cover all changes and modifications of the embodiments of the invention herein which do not constitute departures from the spirit and scope of the invention.

First, according to the present invention, it is possible to use devices other than the photodiodes 51 and 51a for the detection of an input level, an output level or a reflection level.

Secondly, the present invention is also applicable to a system with a working line (WK) and a protection line (PT). For example, in FIG. 2, a pair of (two) working and protection optical amplifying units (not shown) are provided for each of the optical amplifying units 6a, 6b and 6c. Moreover, on each of the input and output side of the two optical amplifying units, there are provided a distributing section (not shown) for branching an optical signal and a selecting section (not shown) for selectively outputting one of optical signals from the two optical amplifying units.

With this arrangement, the transmission of an optical signal is feasible stably without ceasing the optical transmission system not only when a failure occurs in the optical transmission apparatus 10a to 10c, but also when a transmission trouble such as cutoff of an optical fiber occurs, and even when an operator maintains or inspects the optical amplifying units.

Thirdly, an output signal from the former-stage optical amplifier 1 can be subjected to processing other than amplification in the latter stage.

For example, the latter-stage optical processing section can also be constructed as a wavelength dispersion compensator which compensates for the wavelength dispersion of an amplified optical signal, or can also be made as a polarization dispersion compensator which compensates for the polarization dispersion of the amplified optical signal.

That is, an optical module having another function (for example, a wavelength dispersion compensator, polarization dispersion compensator, or the like) can also be provided in place of the former-stage side optical amplifier 1. This configuration enables controlling the output of an optical signal with a simple arrangement, which leads to the extension of the application of the optical transmission system.

Fourthly, latter-stage optical processing sections (for example, optical amplifiers, or optical processing sections) can be provided at three or more stages, and each of the latter-stage optical processing sections can be composed of a latter-stage input level detecting section for detecting a latter-stage input level indicative of an input level of a processed optical signal outputted from a former-stage optical processing section, and an optical signal processing section for handling a processed optical signal undergoing the latter-stage input level detection. This similarly adds easily a function of detecting an off-condition of an optical fiber without suppressing an output level.

What is claimed is:

1. An optical transmission apparatus which amplifies a first optical signal inputted thereto and outputs a first amplified optical signal, comprising:
a former-stage optical processing section including an optical amplifying section for amplifying the first optical signal and outputting a second amplified optical signal;
a latter-stage optical processing section including a first processing section connected to said former-stage optical processing section for handling the second amplified optical signal from said former-stage optical processing section, and a latter-stage input level detecting section for detecting a latter-stage input level representative of an input level of said second amplified optical signal inputted to said first processing section; and
a control section for controlling an output level from said optical amplifying section on the basis of the latter-stage input level detected by said latter-stage input level detecting section and a reference latter-stage input level.

2. An optical transmission apparatus according to claim 1, wherein said control section implements control to lower said output level of said optical amplifying section when said latter-stage input level becomes lower than said reference latter-stage input level.

3. An optical transmission apparatus according to claim 1, wherein said former-stage optical processing section and said latter-stage optical processing section are connected to each other in a state where a dispersion compensator which is of a detachable type is interposed therebetween.

4. An optical transmission apparatus according to claim 2, wherein said former-stage optical processing section and said latter-stage optical processing section are connected to each other in a state where a dispersion compensator which is of a detachable type is interposed therebetween.

5. An optical transmission apparatus according to claim 1, wherein said first processing section included in said latter-stage optical processing section is made to amplify the second amplified optical signal and to output the first amplified optical signal.

6. An optical transmission apparatus which amplifies a first optical signal inputted thereto and outputs a first amplified optical signal, comprising:
a former-stage optical processing section including an optical amplifying section for amplifying the first optical signal, inputted thereto, to one of a first output level and a second output level and for outputting a second amplified optical signal;
a latter-stage optical processing section including a first processing section connected to said former-stage optical processing section for handling the second amplified optical signal from said former-stage optical processing section, and a latter-stage input level detecting section for detecting a latter-stage input level representative of an input level of said second amplified optical signal inputted to said first processing section; and
a control section for controlling said optical amplifying section on the basis of said latter-stage input level detected by said latter-stage input level detecting section and one of a first reference latter-stage input level and a second reference latter-stage input level so that an output level from said optical amplifying section becomes equal to said first output level or said second output level.

7. An optical transmission apparatus which amplifies a first optical signal inputted thereto and outputs a first amplified optical signal, comprising:
a former-stage optical amplification processing section including a first optical amplifying section for amplifying the first optical signal, inputted thereto, to one of a first output level and a second output level and for outputting a second amplified optical signal;
a latter-stage optical processing section including a second optical amplifying section connected to said former-stage optical amplification processing section for amplifying the second amplified optical signal from said former-stage optical amplification processing section and a latter-stage input level detecting section for detecting a latter-stage input level representative of an input level of said second optical signal inputted to said second optical amplifying section; and
a control section for controlling said first optical amplifying section so that an output level from said first amplifying section becomes equal to said first output level when said latter-stage input level detected by said latter-stage input level detecting section becomes higher than a first reference latter-stage input level and said output level from said first amplifying section becomes equal to said second output level when said latter-stage input level detected by said latter-stage input level detecting section becomes lower than a second reference latter-stage input level.

8. An optical transmission apparatus according to claim 7, wherein said control section includes at least a main control section and a latter-stage input level detection control section, and said latter-stage input level detection control section makes a comparison between a reference latter-stage input level taken as a reference level forming one of a first reference input level and a second reference level in said main control section and the detected input level.

9. An optical transmission apparatus according to claim 8, wherein said former-stage optical amplification processing section includes an output level detecting section for detecting an output level of said first optical amplifying section and said control section includes at least a main control section and a former-stage output level control section, and said main control section sets, as a set value, one of a first set value corresponding to said first output level and a second set value corresponding to said second output level and said former-stage output level control section makes a comparison between a signal detected by said output level detecting section and said set value for controlling said first optical amplifying section.

10. An optical transmission module which amplifies a first optical signal inputted thereto and outputs a first amplified optical signal, comprising:
a former-stage optical processing section including a first optical amplifying section for amplifying the first optical signal inputted thereto and for outputting a second amplified optical signal and a first detecting section for detecting a first level signal corresponding to an output level of said first optical amplifying section;
a latter-stage optical processing section including a second optical amplifying section connected to said former-stage optical processing section for amplifying the second amplified optical signal from said former-stage optical processing section and outputting the first amplified optical signal, and a second detecting section for detecting a second level signal corresponding to an input level of said second amplified optical signal inputted to said second optical amplifying section; and
a control section for controlling an output level of said first optical amplifying section on the basis of an output of said first detecting section and an output of said second detecting section.

11. An optical transmission module according to claim 10, wherein said control section controls said first optical amplifying section so that, when said second level signal detected by said second detecting section is equal to or higher than a predetermined reference level, a first output level of said first detecting section approaches a predetermined first output level set value and, when said second level signal detected by said second detecting section is lower than said predetermined reference level, said first output level of said first detecting section approaches a predetermined second output level set value lower than said first output level set value.

12. An optical transmission module according to claim 11, wherein said former-stage optical processing section and said latter-stage optical processing section are connected through an optical fiber to each other in a state where a dispersion compensator detachable from said optical transmission module is interposed therebetween.

13. An optical transmission module according to claim 10, wherein said former-stage optical processing section and said latter-stage optical processing section are connected through an optical fiber to each other in a state where a dispersion compensator detachable from said optical transmission module is interposed therebetween.
